(19) United States
(12) Patent Application Publication
(10) Pub. No.: US 2011/0103634 A1
(43) Pub. Date: May 5, 2011

(54) SYSTEM AND METHOD FOR MECHANICALLY REDUCING UNWANTED WIND NOISE IN AN ELECTRONICS DEVICE

(75) Inventors: Taisen Maddern, Melbourne (AU); Adrian Tan, Melbourne (AU)

(73) Assignee: BLUEANT WIRELESS PTY LIMITED, Richmond (AU)

(21) Appl. No.: 12/829,266

(22) Filed: Jul. 1, 2010

Related U.S. Application Data
(60) Provisional application No. 61/314,963, filed on Mar. 17, 2010.
(60) Provisional application No. 61/257,371, filed on Nov. 2, 2009.

(51) Int. Cl. H04R 19/04

(52) U.S. Cl. 381/359

(57) ABSTRACT

A system and method for mechanically reducing unwanted wind, audio, and other noise in a telecommunications or other electronic device. In accordance with an embodiment, a telecommunications or other electronic device, such as a mobile telephone, computer, personal digital assistant, geographical positioning system (gps) device, camera, video camera and the like, comprises a housing which includes one or more openings or ports for use with one or more microphones. A portion of the housing which contains the ports is overlaid with a combination of one or more metal or plastic grills, and a sound-reducing felt or other material. Used separately or with other features, this provides for mechanical noise reduction, particularly of wind noise. In accordance with different embodiments, the noise reducing combination can be overlaid over the microphone and over the housing, as an add-on module; or can be overlaid over the microphone and beneath the housing, as a manufactured or OEM-supplied feature.

### CLAIM OF PRIORITY

This application claims the benefit of priority to U.S. Provisional Patent Application No. 61/314,963 titled “SYSTEM AND METHOD FOR MECHANICALLY REDUCING UNWANTED WIND NOISE IN AN ELECTRONICS DEVICE”, filed Mar. 17, 2010; and U.S. Provisional Patent Application No. 61/257,371 titled “SYSTEM AND METHOD FOR MECHANICALLY REDUCING UNWANTED WIND NOISE IN A TELECOMMUNICATIONS HEADSET DEVICE”, filed Nov. 2, 2009, each of which applications are incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to telecommunications, audio headsets, speakers, and other communications and electronic devices, such as mobile telephones, computers, personal digital assistants, geographical positioning system (gps) devices, cameras and video cameras, and is particularly related to a system and method for mechanically reducing microphone noise in such a device.

### BACKGROUND

The use of telecommunications and other electronic devices, particularly mobile telephones, computers, personal digital assistants, geographical positioning system (gps) devices, cameras, video cameras and the like, continues to become widespread, and both business and casual users alike commonly have one or more, and in some instances several such devices. Such devices are no longer confined to people's homes and businesses, but are commonly used in other environments, such as while driving, in the park, or at sporting and other entertainment events. However, one of the commonly encountered problems, say while using a device outdoors, is that the user's voice may not be properly heard. For example, while talking to an gps device that allows voice input, such as a vehicle or motorbike-mounted gps, the user's voice may not be heard over exterior wind noise, such that the device cannot be operated properly. Similarly, a person using a mobile phone outdoors may not be well heard by a person at the other end. This is particularly pertinent in headset and other small devices, since such devices are generally small enough to be mounted on a person's ear, which necessarily places the microphone quite far from the person's mouth, and in such a position that it is exposed to wind and other noise. This is the general area that embodiments of the present invention are intended to address.

### SUMMARY

Described herein is a system and method for mechanically reducing unwanted wind, audio, and other noise in a telecommunications or other electronic device. In accordance with an embodiment, a telecommunications or other electronic device, such as a mobile telephone, computer, personal digital assistant, geographical positioning system (gps) device, camera, video camera and the like, comprises a housing which includes one or more openings or ports for use with one or more microphones. A portion of the housing which contains the ports is overlaid with a combination of one or more metal or plastic grills, and a sound-reducing felt or other material. Used separately or with other features, this provides for mechanical noise reduction, particularly of wind noise. In accordance with different embodiments, the noise reducing combination can be overlaid over the microphone and over the housing, as an add-on module; or can be overlaid over the microphone and beneath the housing, as a manufactured or OEM-supplied feature.

### BRIEF DESCRIPTION OF THE DRAWINGS

FIG. 1 shows an illustration of an example device, such as a headset, that can utilize mechanical noise reduction, in accordance with an embodiment.

FIG. 2 shows a cross-section illustration of an external mounted noise reducing combination, in accordance with an embodiment.

FIG. 3 shows a cross-section illustration of an internally mounted noise reducing combination, in accordance with an embodiment.

FIG. 4 shows an illustration of a camera that includes a mechanical noise reducing combination, in accordance with an embodiment.

FIG. 5 shows an illustration of a gps device that includes a mechanical noise reducing combination, in accordance with an embodiment.

### DETAILED DESCRIPTION

Described herein is a system and method for mechanically reducing unwanted wind, audio, and other noise in a telecommunications headset or other device. In accordance with an embodiment, a telecommunications or other electronic device, such as a mobile telephone, computer, personal digital assistant, geographical positioning system (gps) device, camera, video camera and the like, comprises a housing which includes one or more openings or ports for use with one or more microphones. A portion of the housing which contains the ports is overlaid with a combination of one or more metal or plastic grills, and a sound-reducing felt or other material. Used separately or with other features, this provides for mechanical noise reduction, particularly of wind noise. In accordance with different embodiments, the noise reducing combination can be overlaid over the microphone and over the housing, as an add-on module; or can be overlaid over the microphone and beneath the housing, as a manufactured or OEM-supplied feature.

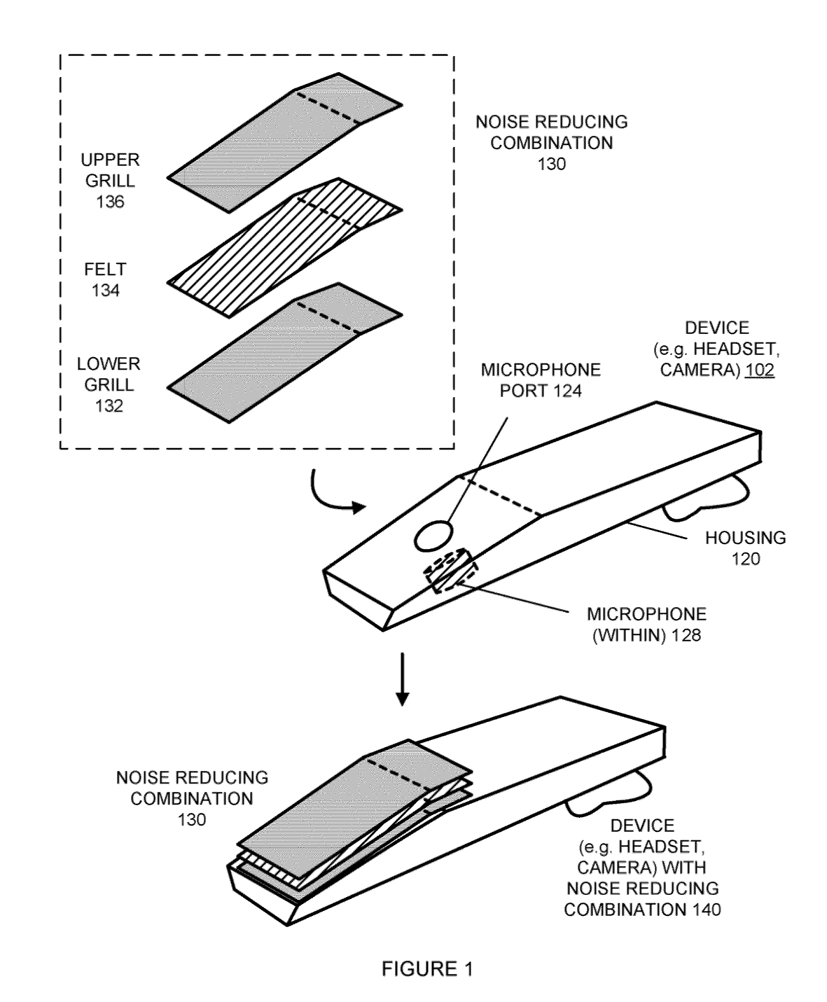

FIG. 1 shows an illustration of an example device, such as a headset, that can utilize mechanical noise reduction, in accordance with an embodiment. As shown in FIG. 1, a grill/felt/grill combination, including one or more metal or plastic grills and a sound-reducing felt material can be used to mechanically reduce unwanted noise. In accordance with an embodiment, the device, such as a headset, camera, gps or other electronic device 102 comprises a housing 120, which includes one or more openings or ports 124, and microphones 128 therein. In accordance with an embodiment, the microphones can be held in place within a microphone mounting boot and/or connected to a noise cancellation logic/circuit, such as which can be provided as a printed circuit board (PCB), and which in turn is powered by an internal battery, as described for example in copending U.S. Provisional Patent Application “SYSTEM AND METHOD FOR MECHANICALLY REDUCING UNWANTED WIND NOISE IN A TELECOMMUNICATIONS HEADSET DEVICE”, Application No. 61/257,371, filed Nov. 2, 2009. The portion of the housing which contains the microphone port is overlaid with a grill/felt/grill noise reducing combination 130, including one or more metal or plastic grills 132, 136 and a sound-reducing felt material 134, which together provides mechanical noise reduction. In accordance with an embodiment, the lower grill is approximately 5 mm in thickness; and the upper grill is approximately 3 mm in thickness. Different implementations and constructions, with different requirements, may benefit from different arrangements, materials, and thicknesses of the grills and/or the sound-reducing materials. The noise reducing combination can be mounted to, or formed as part of the device, to provide a device with the noise reducing combination 140.

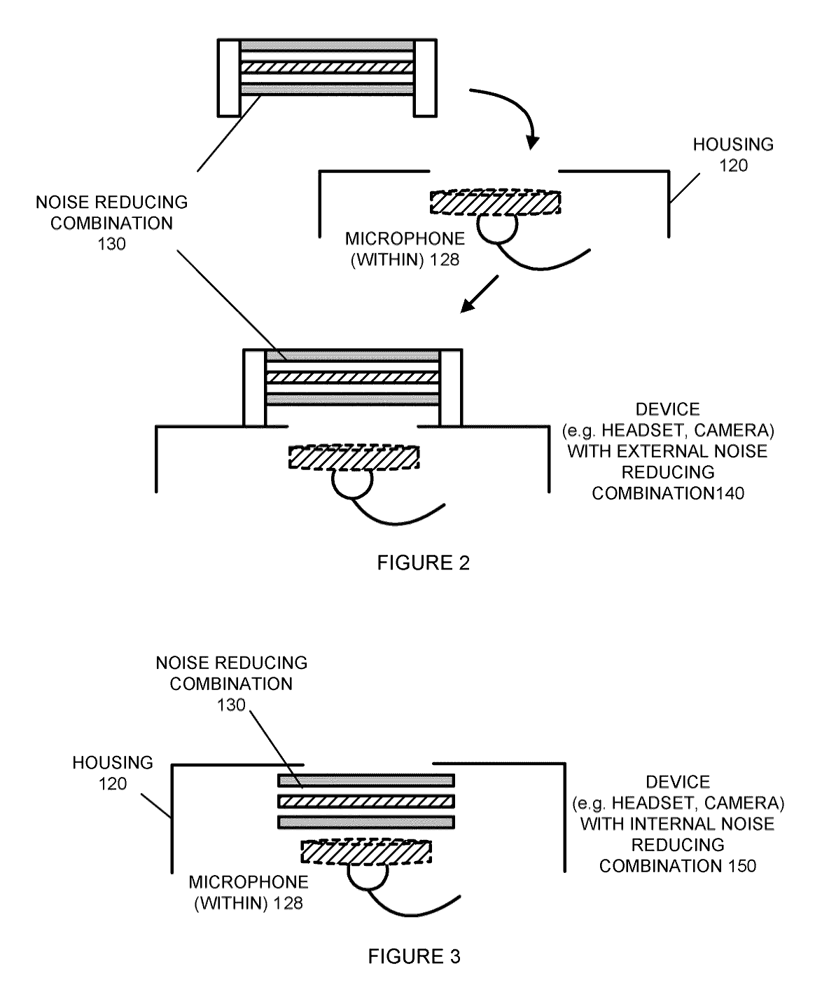

FIG. 2 shows a cross-section illustration of an external mounted noise reducing combination, in accordance with an embodiment. As shown in FIG. 2, the noise reducing combination 130 of grill and felt layers can be mounted to the housing 120, over the microphone 128, much as an add-on or after-market module, to provide a device with the noise reducing combination 140.

FIG. 3 shows a cross-section illustration of an internally mounted noise reducing combination, in accordance with an embodiment. As shown in FIG. 3, in those implementations in which the feature is provided as a manufactured or OEM-supplied feature, the noise reducing combination 130 of grill and felt layers can be mounted within the housing 120, over the microphone 128, to provide a device with the noise reducing combination 150 built-in.

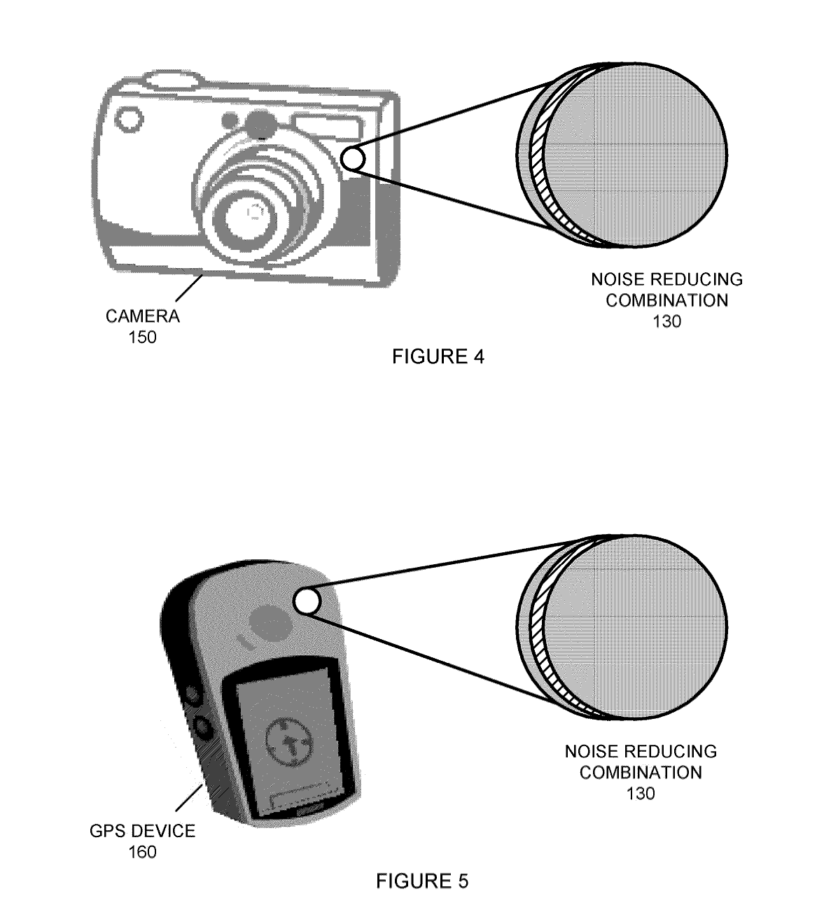

FIG. 4 shows an illustration of a camera 150 that includes a mechanical noise reducing combination 130, in accordance with an embodiment; while FIG. 5 shows an illustration of a gps device 160 that includes a mechanical noise reducing combination 130, in accordance with an embodiment. In accordance with other embodiments, the feature can be included in any telecommunications or other electronic device, such as a mobile telephone, computer, personal digital assistant, geographical positioning system (gps) device, camera, video camera and the like.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. For example, as described above, different implementations, with different requirements, may benefit from different arrangements, materials, and thicknesses of the grills and/or the sound-reducing materials. It is intended that the scope of the invention be defined by the following claims and their equivalence.

Some aspects of the present invention may be conveniently implemented using one or more conventional general purpose or specialized digital computer, computing device, machine, microprocessor, or electronic circuits, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

What is claimed is:

1. A system for reducing noise in an electronic device, comprising:
a housing enclosing one or more microphones; and
a noise reducing combination over the one or microphones, including one or more metal or plastic grills placed over the microphone, and a wind-resistant felt or other material placed between the microphone and the grills and/or between the one or more grills, to reduce the effect of wind hitting the microphones.

2. The system of claim 1, wherein the system includes two metal or plastic grills placed over the microphone, including a first grill placed nearest the microphone, covered with the wind-resistant felt or other material, and then a second grill covering the wind-resistant felt.

3. The system of claim 1, wherein the system is provided in a telecommunications, Bluetooth, or other headset.

4. The system of claim 1, wherein the system is provided in a speakerphone, or in-car speaker.

5. The system of claim 1, wherein the system is provided in one of a computer, personal digital assistant, geographical positioning system device, camera, video camera and the like.

6. A method for reducing noise in an electronic device, comprising:
providing a housing enclosing one or more microphones; and
providing a noise reducing combination over the one or microphones, including one or more metal or plastic grills placed over the microphone, and a wind-resistant felt or other material placed between the microphone and the grills and/or between the one or more grills, to reduce the effect of wind hitting the microphones.

7. The method of claim 6, wherein the system includes two metal or plastic grills placed over the microphone, including a first grill placed nearest the microphone, covered with the wind-resistant felt or other material, and then a second grill covering the wind-resistant felt.

8. The method of claim 6, wherein the system is provided in a telecommunications, Bluetooth, or other headset.

9. The method of claim 6, wherein the system is provided in a speakerphone, or in-car speaker.

10. The method of claim 6, wherein the system is provided in one of a computer, personal digital assistant, geographical positioning system device, camera, video camera and the like.
